(19) United States
(12) Patent Application Publication
(10) Pub. No.: US 2025/0286336 A1
(43) Pub. Date: Sep. 11, 2025

(54) CONNECTOR AND CONNECTOR MANUFACTURING METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Teruo HARA, Mie (JP)

(21) Appl. No.: 18/862,552

(22) PCT Filed: Apr. 24, 2023
(86) PCT No.: PCT/JP2023/016075

§ 371 Date: Nov. 4, 2024

(30) Foreign Application Priority Data
May 11, 2022 (JP) 2022-077958

(51) Int. Cl. H01R 43/24; H01R 13/426; H01R 13/506; H01R 13/52

(52) U.S. Cl. CPC H01R 43/24; H01R 13/426; H01R 13/506; H01R 13/5208; H01R 13/5202

(57) ABSTRACT

A connector includes a wire including a core wire and an insulation coating covering an outer periphery of the core wire, a terminal to be connected to the core wire, an inner housing including a terminal accommodating portion for accommodating the terminal inside, a rear holder to be attached to a rear part of the inner housing and a collective sealing portion to be mounted into the rear holder. The rear holder includes a wire insertion hole, through which the wire is inserted. The collective sealing portion includes an inner sealing portion for sealing the wire inserted through the wire insertion hole. The insulation coating of the wire includes a sheath portion and a body portion separate from each other. The sheath portion is disposed forward of the body portion and slidable with respect to the core wire.

### TECHNICAL FIELD

The present disclosure relates to a connector and a connector manufacturing method.

### BACKGROUND

Conventionally, a connector described in Japanese Patent Laid-Open Publication No. 2019-145208 (Patent Document 1 below) is known as a connector for accommodating a terminal-equipped wire, in which a terminal is connected to a core wire exposed from an end of a wire. This connector is provided a terminal including a terminal body and a slide portion, a connector housing including a cavity for accommodating the terminal and a rear holder to be locked to the rear end of the terminal. With the slide portion held at a complete locking position with respect to the terminal body, an upper contact portion of the slide portion is in contact with an upper connection piece of the terminal body from above and presses the upper connection piece downward, and a lower contact portion of the slide portion is in contact with a lower connection piece of the terminal body from below and presses the lower connection piece upward. In this way, the core wire is sandwiched from upper and lower sides by the upper and lower connection pieces and the wire and the terminal are electrically connected.

### PRIOR ART DOCUMENT

### Patent Document

Patent Document 1: JP 2019-145208 A

### SUMMARY OF THE INVENTION

### Problems to be Solved

The above connector is a non-waterproof connector. If an attempt is made to make this connector waterproof, the connector housing is first used as an inner housing, an outer housing to be disposed on an outer peripheral side of this inner housing is provided, and the inner housing is accommodated to be surrounded by the outer housing and the rear holder. Then, it is thought to mount a one-piece rubber plug into a rear end part of the inner housing to waterproof the wire inserted through a wire insertion hole and mount a rubber ring between the rear holder and the outer housing, thereby waterproofing the inside of the rear holder and the inside of the outer housing.

However, in the configuration of the above waterproof connector, when the wire is inserted into the wire insertion hole, the core wire exposed in a tip part of the wire may damage a sealing portion of the one-piece rubber plug.

### Means to Solve the Problem

The present disclosure is directed to a connector with a wire including a core wire and an insulation coating covering an outer periphery of the core wire, a terminal to be connected to the core wire, an inner housing including a terminal accommodating portion for accommodating the terminal inside, a rear holder to be attached to a rear part of the inner housing, and a collective sealing portion to be mounted into the rear holder, the rear holder including a wire insertion hole, the wire being inserted through the wire insertion hole, the collective sealing portion including an inner sealing portion for sealing the wire inserted through the wire insertion hole, the insulation coating of the wire including a sheath portion and a body portion separate from each other, and the sheath portion being disposed forward of the body portion and slidable with respect to the core wire.

### Effect of the Invention

According to the present disclosure, it is possible to suppress the damage of a collective sealing portion in a connector.

### BRIEF DESCRIPTION OF THE DRAWINGS

FIG. 1 is a perspective view of a connector according to an embodiment.

FIG. 2 is an exploded perspective view of the connector.

FIG. 3 is a front view of the connector.

FIG. 4 is a section along A-A of FIG. 3.

FIG. 5 is a section along B-B of FIG. 3.

FIG. 6 is a side view of the connector.

FIG. 7 is a section along C-C of FIG. 6.

FIG. 8 is a front view of a rear holder integrally configured with a collective sealing portion.

FIG. 9 is a section along D-D of FIG. 8.

FIG. 10 is a front view when only the rear holder is viewed from front.

FIG. 11 is a perspective view in section along E-E of FIG. 10 when viewed obliquely from a front upper side.

FIG. 12 is a side view when only the rear holder is viewed laterally.

FIG. 13 is a section along F-F of FIG. 12.

FIG. 14 is a view in section along A-A of FIG. 3 showing a state where a wire is inserted through a wire insertion hole and a sheath portion is in contact with an inner sealing portion.

FIG. 15 is a view in section along A-A of FIG. 3 showing a state where the wire is pushed further forward from the state of FIG. 14 and the sheath portion is slid with respect to the core wire.

FIG. 16 is a view in section along A-A of FIG. 3 showing a state where the wire is pushed further forward from the state of FIG. 15, the core wire is inside the terminal and a body portion is sealed by the inner sealing portion.

### DETAILED DESCRIPTION TO EXECUTE THE INVENTION

### [Description of Embodiments of Present Disclosure]

First, embodiments of the present disclosure are listed and described below.

(1) The connector of the present disclosure is provided with a wire including a core wire and an insulation coating covering an outer periphery of the core wire, a terminal to be connected to the core wire, an inner housing including a terminal accommodating portion for accommodating the terminal inside, a rear holder to be attached to a rear part of the inner housing, and a collective sealing portion to be mounted into the rear holder, the rear holder including a wire insertion hole, the wire being inserted through the wire insertion hole, the collective sealing portion including an inner sealing portion for sealing the wire inserted through the wire insertion hole, the insulation coating of the wire including a sheath portion and a body portion separate from each other, and the sheath portion being disposed forward of the body portion and slidable with respect to the core wire.

According to this configuration, the front end part of the core wire can be suppressed from contacting the inner sealing portion of the collective sealing portion by inserting the wire into the wire insertion hole with the front end part of the core wire protected by the sheath portion. Therefore, the damage of the collective sealing portion can be suppressed.

(2) Preferably, the inner sealing portion seals the body portion.

According to this configuration, waterproofness by the collective sealing portion can be ensured.

(3) Preferably, the connector is further provided with an outer housing to be assembled with the rear holder while accommodating the inner housing inside, and an outer sealing portion for sealing between the rear holder and the outer housing.

According to this configuration, the insides of the inner housing and the rear holder can be waterproofed by providing the outer housing and the outer sealing portion.

(4) Preferably, the outer sealing portion is integrally formed to the collective sealing portion.

According to this configuration, the number of components can be reduced since the outer sealing portion is integrally provided to the collective sealing portion.

(5) Preferably, the collective sealing portion and the rear holder are constituted by one member.

According to this configuration, mounting man-hours can be reduced since the collective sealing portion needs not be mounted into the rear holder. For example, the collective sealing portion and the rear holder may be configured into one member by forming the collective sealing portion in the rear holder by two-color molding.

(6) A connector manufacturing method of the present disclosure is a manufacturing method for a connector with a wire including a core wire and an insulation coating covering an outer periphery of the core wire, a terminal, an inner housing including a terminal accommodating portion, a rear holder including a wire insertion hole, and a collective sealing portion to be mounted into the rear holder, the collective sealing portion sealing the wire inserted through the wire insertion hole, and includes accommodating the terminal inside the terminal accommodating portion, attaching the rear holder having the collective sealing portion mounted therein to a rear part of the inner housing, forming a sheath portion and a body portion disposed rearward of the sheath portion by cutting off a front end part of the insulation coating of the wire, protecting a front end part of the core wire by the sheath portion by sliding the sheath portion forward with respect to the core wire, inserting the wire having the front end part of the core wire protected by the sheath portion into the wire insertion hole of the rear holder and bringing the front end part of the core wire to inside of the terminal, and connecting the core wire and the terminal.

Since such a connector manufacturing method includes forming the sheath portion in the insulation coating and protecting the front end part of the core wire by the sheath portion, the front end part of the core wire can be suppressed from contacting the collective sealing portion when the wire is inserted into the wire insertion hole. Therefore, the damage of the collective sealing portion can be suppressed.

### [Details of Embodiment of Present Disclosure]

Hereinafter, an embodiment of the present disclosure is described. The present disclosure is not limited to these illustrations, but is represented by claims and intended to include all changes in the scope of claims and in the meaning and scope of equivalents.

### EMBODIMENT

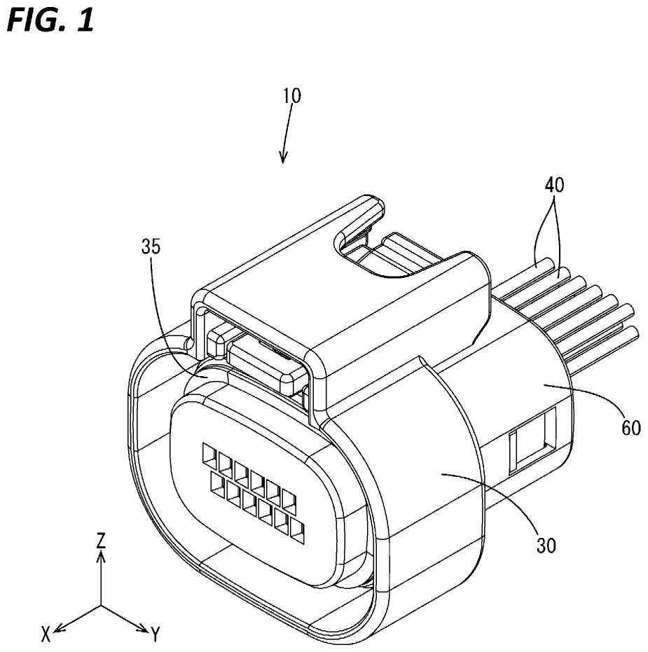

The embodiment of the present disclosure is described with reference to FIGS. 1 to 16. In the following description, a direction indicated by an arrow Z is referred to as an upward direction, a direction indicated by an arrow X is referred to as a forward direction and a direction indicated by an arrow Y is referred to as a leftward direction. Note that, for a plurality of identical members, only some members may be denoted by a reference sign and the other members may not be denoted by the reference sign.

### [Connector]

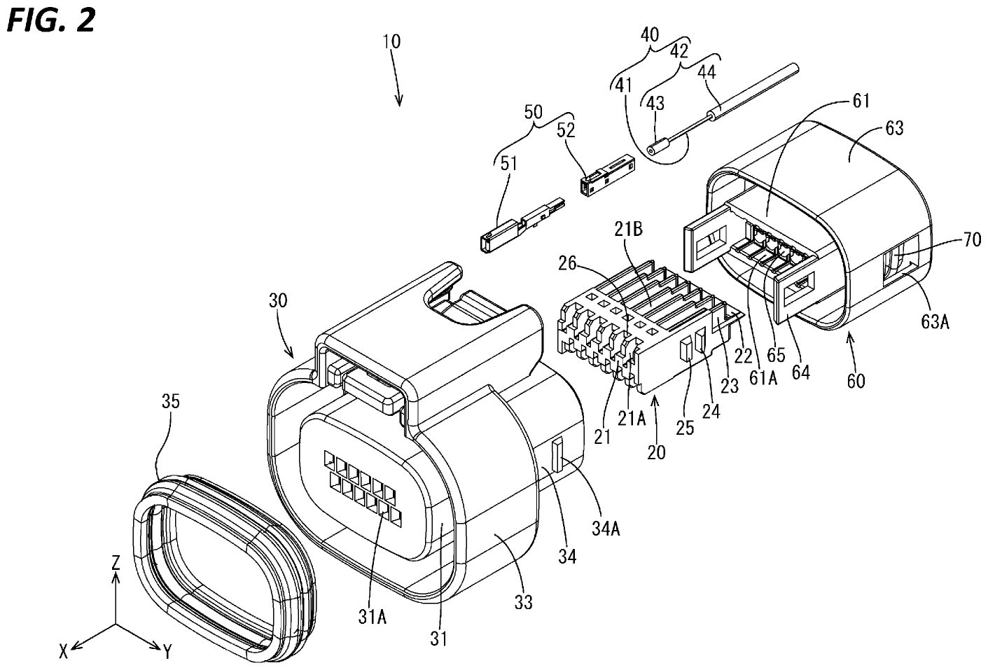

As shown in FIGS. 1 and 2, the connector 10 is provided with an inner housing 20, an outer housing 30, a sealing ring 35, terminals 50, wires 40, a rear holder 60 and a collective sealing portion 70.

### [Wire]

The wire 40 is provided with a core wire 41 and an insulation coating 42 made of insulating synthetic resin for surrounding the outer peripheral surface of the core wire 41. The insulation coating 42 is stripped in an end part of the wire 40 to expose the core wire 41. The core wire 41 is a so-called single-core wire composed of one metal wire. Note that the core wire 41 may be a stranded wire formed by twisting a plurality of thin metal wires. An arbitrary metal such as copper, copper alloy, aluminum or aluminum alloy can be appropriately selected as a metal constituting the core wire 41 if necessary. The core wire 41 of this embodiment is made of copper or copper alloy.

### [Sheath Portion, Body Portion]

The insulation coating 42 is provided with a sheath portion 43 and a body portion 44 separate from the sheath portion 43 and disposed behind the sheath portion 43. The sheath portion 43 is slidable in an extension direction (front-rear direction) of the wire 40 with respect to the core wire 41. The sheath portion 43 is formed by being cut off from the body portion 44 by a wire stripper or the like.

### [Terminal]

The terminal 50 is a female terminal and provided with a terminal body 51 made of metal and a slide portion 52 relatively slidable with respect to the terminal body 51. The terminal body 51 is formed into a predetermined shape by a known method such as press-working, cutting or casting. An arbitrary metal such as copper, copper alloy, aluminum, aluminum alloy or stainless steel can be appropriately selected as a metal constituting the terminal body 51 if necessary. The terminal body 51 of this embodiment is made of copper or copper alloy. A plating layer may be formed on the surface of the terminal body 51. An arbitrary metal such as tin, nickel or silver can be appropriately selected as a metal constituting the plating layer if necessary. Tin plating is applied to the terminal body 51 of this embodiment.

### [Terminal Body]

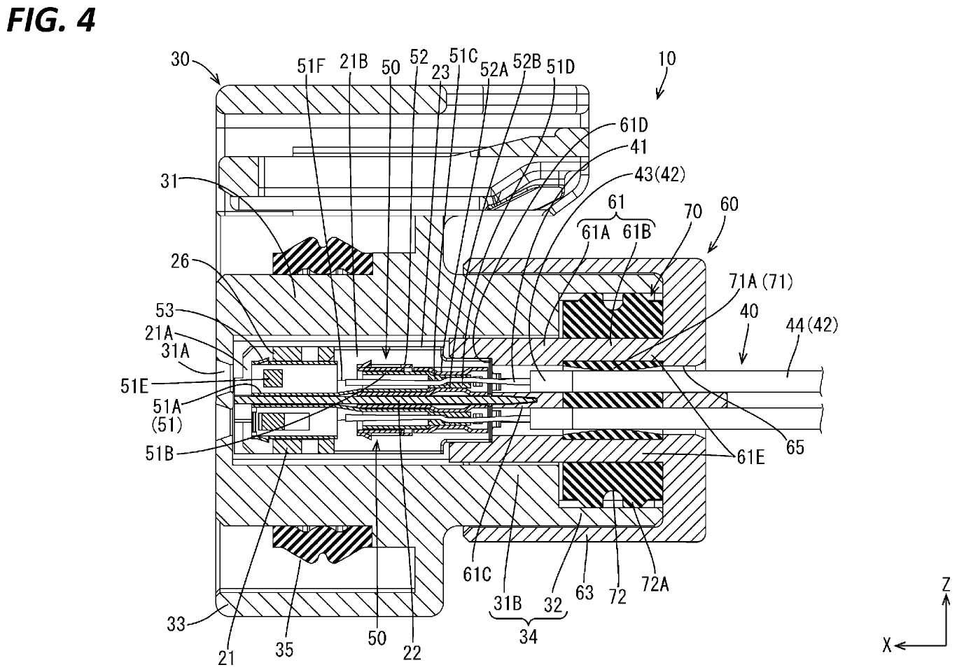

As shown in FIG. 4, the terminal body 51 includes a connecting tube portion 51A in the form of a rectangular tube, into which a mating male terminal (not shown) is inserted, a base portion 51B in the form of a rectangular tube disposed behind the connecting tube portion 51A and an upper connection piece 51C and a lower connection piece 51D extending rearward from the base portion 51B. The front end of the connecting tube portion 51A is open to enable the insertion of the mating male terminal.

A resiliently deformable resilient contact piece 51E is disposed on a side wall of the connecting tube portion 51A. The male terminal inserted into the connecting tube portion 51A contacts the resilient contact piece 51E. Further, a front end part of the upper wall of the connecting tube portion 51A is provided with a locking lance 53 made of metal and formed by cutting and raising a part of the connecting tube portion 51A.

The upper connection piece 51C is formed to be resiliently deformable in a vertical direction with a rear end part of the upper wall of the base portion 51B as a fulcrum. The lower connection piece 51D is formed to be resiliently deformable in the vertical direction with a rear end part of the lower wall of the base portion 51B as a fulcrum. The upper and lower connection pieces 51C, 51D are formed to have substantially the same length in a front-rear direction.

The terminal body 51 further includes a terminal window portion 51F open upward at a position behind the connecting tube portion 51A and in front of the base portion 51B. A front end part of the core wire 41 can be detected through the terminal window portion 51F with the core wire 41 disposed in a space between the upper and lower connection pieces 51C, 51D. Detectable means visually confirmable from outside by a worker, detectable from outside by a camera (not shown) or capable of electrically detecting the front end part of the core wire 41 by inserting a probe (not shown) from outside.

### [Slide Portion]

The slide portion 52 is in the form of a rectangular tube extending in the front-rear direction. The slide portion 52 is formed by a known method such as cutting, casting or press-working if necessary. An arbitrary metal such as copper, copper alloy, aluminum, aluminum alloy or stainless steel can be appropriately selected as a metal constituting the slide portion 52 if necessary. The slide portion 52 of this embodiment is made of copper or copper alloy. A plating layer may be formed on the surface of the slide portion 52. An arbitrary metal such as tin, nickel or silver can be appropriately selected as a metal constituting the plating layer if necessary. Tin plating is applied to the slide portion 52 of this embodiment.

A cross-sectional shape of the slide portion 52 is the same as or somewhat larger than that of a region of the terminal body 51 where the upper and lower connection pieces 51C, 52D are provided. In this way, the slide portion 52 is externally fittable to the region of the terminal body 51 where the upper and lower connection pieces 51C, 52D are provided.

An upper contact portion 52A projecting downward is provided on the lower surface of the upper wall of the slide portion 52. A lower contact portion 52B projecting upward is provided on the upper surface of the lower wall of the slide portion 52.

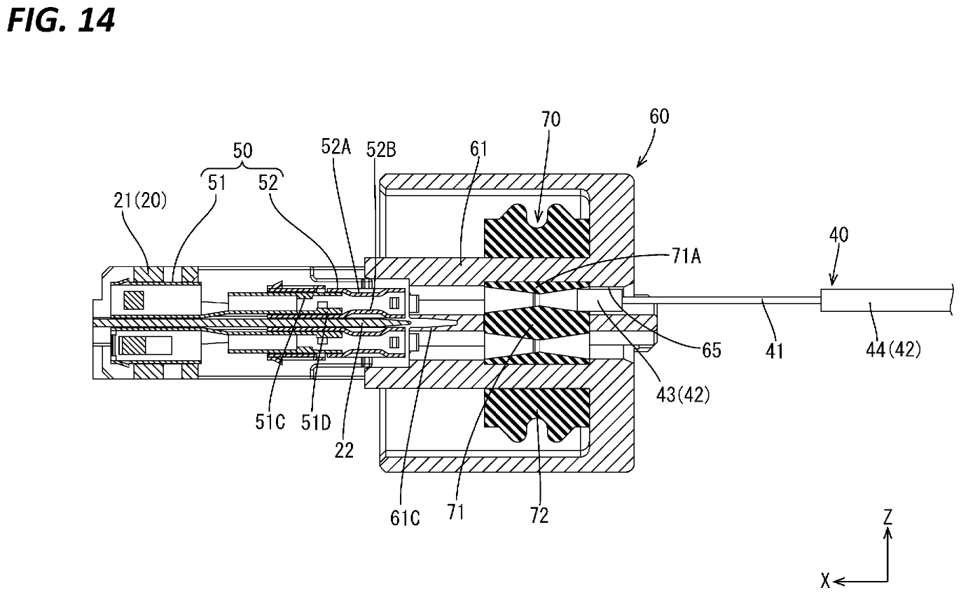

The slide portion 52 is slidable between a temporary locking position (position of the slide portion 52 in FIGS. 14 to 16) and a complete locking position (position of the slide portion 52 in FIG. 4) set to be forward of the temporary locking position in a state externally fit to the region of the terminal body 51 where the upper and lower connection pieces 51C, 51D are provided. With the slide portion 52 held at the complete locking position with respect to the terminal body 51, the upper contact portion 52A is in contact with the upper surface of the upper connection piece 51C from above and the lower contact portion 52B is in contact with the lower surface of the lower connection piece 51D from below.

With the slide portion 52 held at the complete locking position with respect to the terminal body 51, the upper contact portion 52A presses the upper connection piece 51C from above, whereby the upper connection piece 51C is resiliently deformed downward. Further, the lower contact portion 52B presses the lower connection piece 51D from below, whereby the lower connection piece 51D is resiliently deformed upward. In this way, the core wire 41 is sandwiched in the vertical direction by the resiliently deformed upper and lower connection pieces 51C, 51D in a state where the core wire 41 is disposed to extend in the front-rear direction in the space between the upper and lower connection pieces 51C, 51D and the slide portion 52 is held at the complete locking position with respect to the terminal body 51. That is, the upper connection piece 51C contacts the core wire 41 from above by being pressed downward by the upper contact portion 52A, and the lower connection piece 51D contacts the core wire 41 from below by being pressed upward by the lower contact portion 52B.

A front part of the upper connection piece 51C projects downward, a rear part of the lower connection piece 51D projects upward, and these projecting parts are shifted in the front-rear direction. Thus, the core wire 41 is held in a state bent in the vertical direction. In this way, the core wire 41 is electrically connected to the terminal 50 and firmly held not to come out against the rearward pulling of the wire 40.

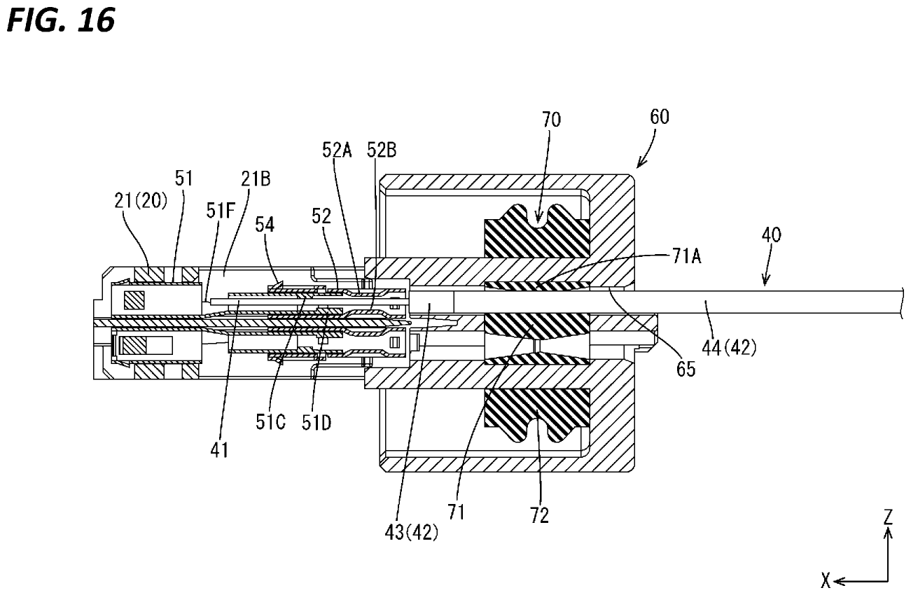

As shown in FIG. 16, the front end part of the slide portion 52 is provided with a jig contact portion 54 projecting upward from the upper wall. An unillustrated jig comes into contact with the jig contact portion 54 from behind and the slide portion 52 is pushed forward by the jig, whereby the slide portion 52 is movable forward.

### [Inner Housing]

As shown in FIG. 2, the inner housing 20 is made of insulating synthetic resin and includes a terminal accommodating portion 21 for accommodating the plurality of terminals 50. The inner housing 20 has a substantially rectangular parallelepiped shape flat in the vertical direction and extending in the lateral direction. The terminal accommodating portion 21 includes a plurality of cavities 21A penetrating therethrough in the front-rear direction. The plurality of cavities 21 are arranged in parallel at intervals in the lateral direction in two upper and lower stages. The cavities 21A formed in the upper stage and the cavities 21 formed in the lower stage are disposed at positions shifted in the lateral direction when viewed from above. Note that the number of the cavities 21A is arbitrary and the number of the stages in the vertical direction is also arbitrary.

The unillustrated male terminal is insertable into the cavity 21A from front. As shown in FIG. 4, the terminal 50 is inserted into the cavity 21A from behind and can be accommodated inside the terminal accommodating portion 21.

With the terminal 50 accommodated in the cavity 21A, a connector window portion 21B is formed at a position corresponding to the terminal window portion 51F of the terminal 50 in the terminal accommodating portion 21. By this connector window portion 21B, the terminal window portion 51F communicates with outside. The terminal window portion 51F of the terminal 50 is detectable through the connector window portion 21B. In this way, the front end part of the core wire 41 is detectable from outside through the connector window portion 21B and the terminal window portion 51F.

As shown in FIG. 2, the inner housing 20 includes a separation wall 22 partitioning between the cavities 21A in the upper stage and the cavities 21A in the lower stage. The separation wall 22 extends rearward from rear end parts of the cavities 21A. Partition walls 23 extending in the front-rear direction and projecting upward or downward are respectively provided on the upper and lower surfaces of the separation wall 22. The terminals 50 accommodated in the respective cavities 21A are electrically insulated from the terminals 50 adjacent in the lateral direction by these partition walls 23.

Temporary lock portions 24 projecting outward are provided at positions near rear end parts of both left and right side walls of the inner housing 20, and complete locking portions 25 are provided at positions forward of these temporary locking portions 24.

As shown in FIG. 4, a lance hole 26 open upward is provided on a front end side of the cavity 21A in the upper stage, and a lance hole 26 open downward is provided on a front end side of the cavity 21A in the lower stage. The locking lance 53 of the terminal 50 is locked to an inner wall constituting the lance hole 26, whereby the terminal 50 is held in a state accommodated in the cavity 21A.

### [Rear Holder]

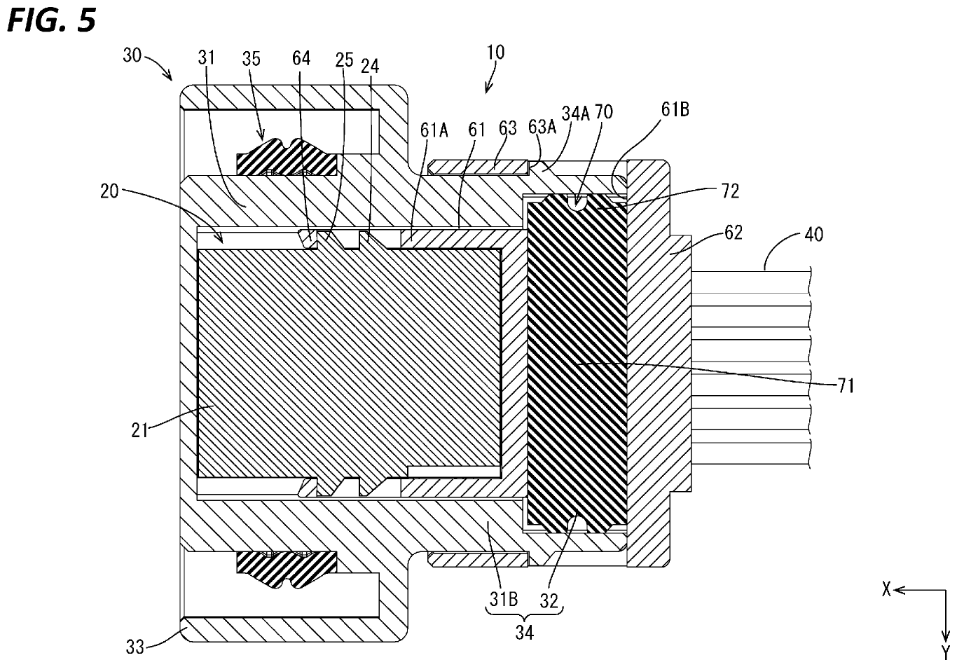

As shown in FIGS. 4 and 5, the rear holder 60 is made of insulating synthetic resin and provided with a holder base portion 62, a holder body 61 projecting forward from the holder base portion 62 and a tubular protection wall 63 disposed on an outer peripheral side of the holder body 61 and projecting forward from the holder base portion 62. The rear holder 60 is formed by injection-molding the insulating synthetic resin.

The holder body 61 includes a box-shaped holder receptacle 61A open forward and a seal mounting portion 61B provided continuously with a rear side of the holder receptacle 61A. The holder receptacle 61A is externally fit to a rear part of the inner housing 20. As shown in FIG. 2, substantially gate-shaped lock receiving portions 64 are provided on front end parts of both left and right side walls of the holder receptacle 61A. As shown in FIG. 5, the lock receiving portions 64 are resiliently lockable to the temporary lock portions 24 and the complete lock portions 25 of the inner housing 20.

By locking the temporary lock portions 24 of the inner housing 20 and the lock receiving portions 64 of the holder body 61, the rear holder 60 is held at a temporary locking position (see FIGS. 14 to 16) with respect to the inner housing 20. Further, by locking the complete lock portions 25 of the inner housing 20 and the lock receiving portions 64 of the holder body 61, the rear holder 60 is held at a complete locking position (position of the rear holder 60 shown in FIG. 5) with respect to the inner housing 20.

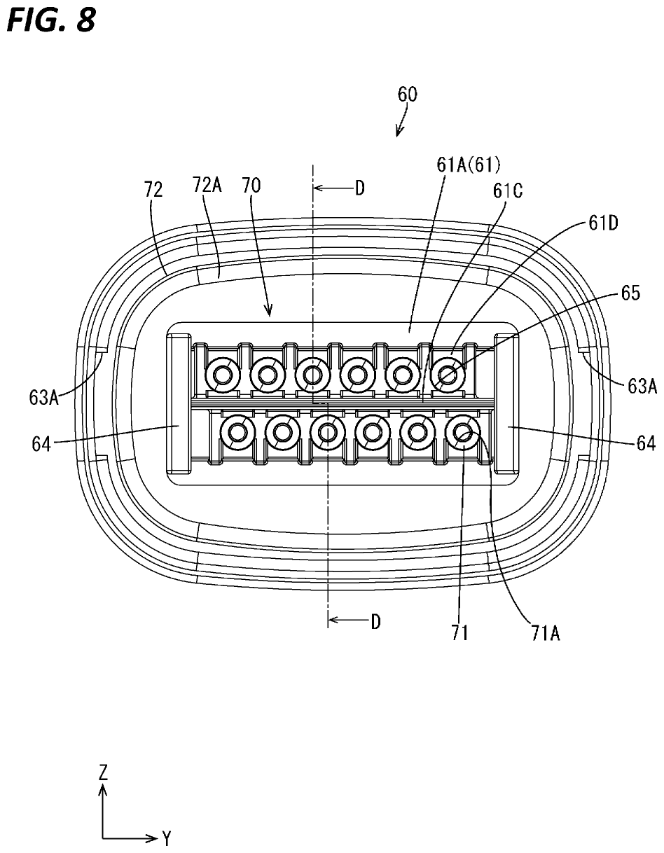

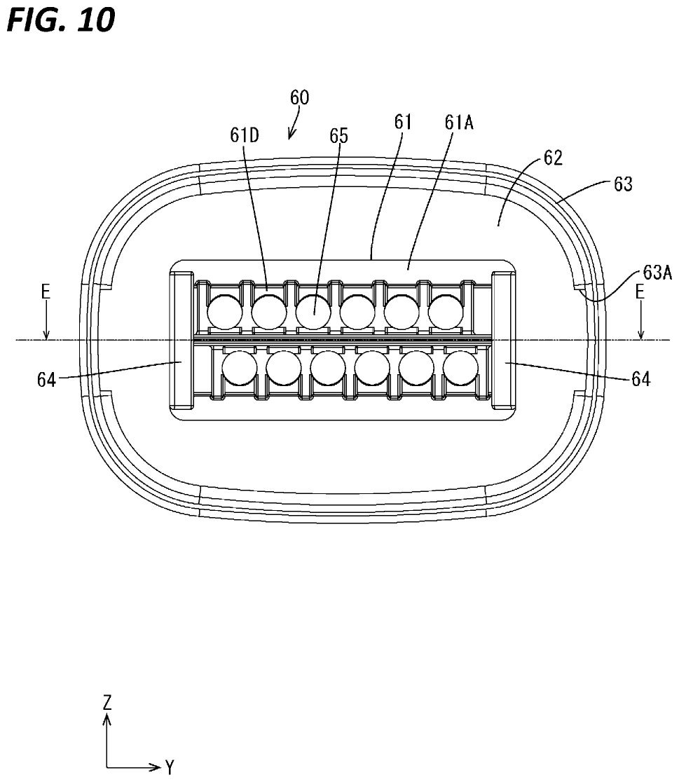

As shown in FIGS. 8 and 10, the rear holder 60 includes a plurality of wire insertion holes 65, through which the wires 40 are inserted. The plurality of wire insertion holes 65 are arranged in parallel in the lateral direction and provided in two upper and lower stages. The respective wire insertion holes 65 are provided at positions corresponding to the respective cavities 21A of the inner housing 20. An inner diameter of the wire insertion hole 65 is set to be equal to or somewhat larger than an outer diameter of the insulation coating 42 of the wire 40.

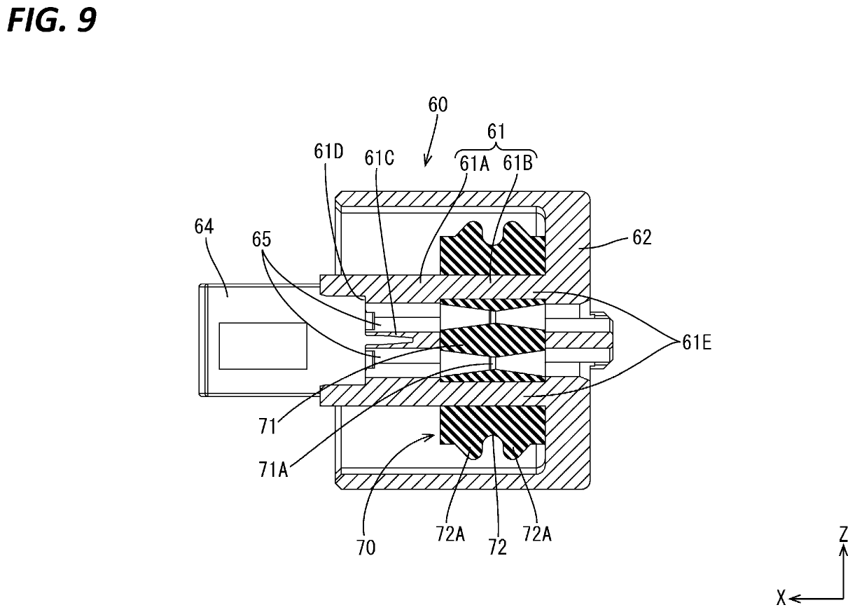

As shown in FIG. 9, a separation wall receiving portion 61C is provided near a vertical center in the back wall of the holder receptacle 61A. This separation wall receiving portion 61C is open forward and a vertical dimension of an opening is set to be equal to or somewhat larger than a vertical thickness of the separation wall 22 of the inner housing 20.

As shown in FIG. 14, with the rear holder 60 held at the temporary locking position with respect to the inner housing 20, the separation wall receiving portion 61C of the holder body 61 is located behind the rear end edge of the separation wall 22 of the inner housing 20. As shown in FIG. 4, with the rear holder 60 held at the complete locking position with respect to the inner housing 20, the separation wall 22 of the inner housing 20 is fit in the opening of the separation wall receiving portion 61C of the rear holder 60. In this way, a position shift of the rear holder 60 in the vertical direction with respect to the inner housing 20 is suppressed.

A step 61D is formed at the front end position of the wire insertion hole 65 on the inner wall of the holder receptacle 61A as shown in FIG. 9. This step 61D comes into contact with a rear end part of the slide portion 52 from behind when the rear holder 60 is moved from the temporary locking position to the complete locking position with respect to the inner housing 20. In this way, the terminal 50 is held in a state accommodated in the cavity 21A of the inner housing 20 and prevented from coming out rearward.

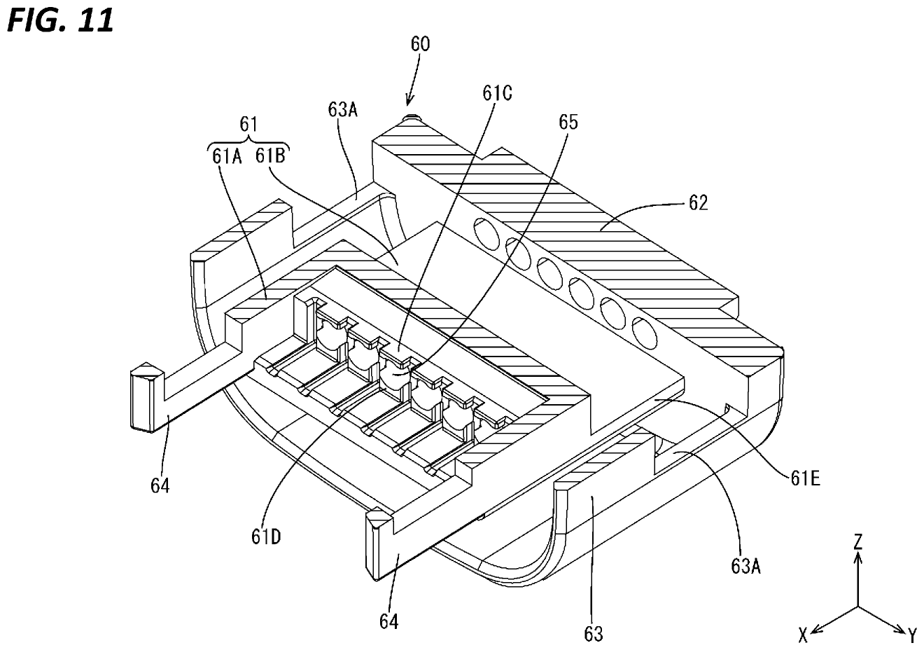

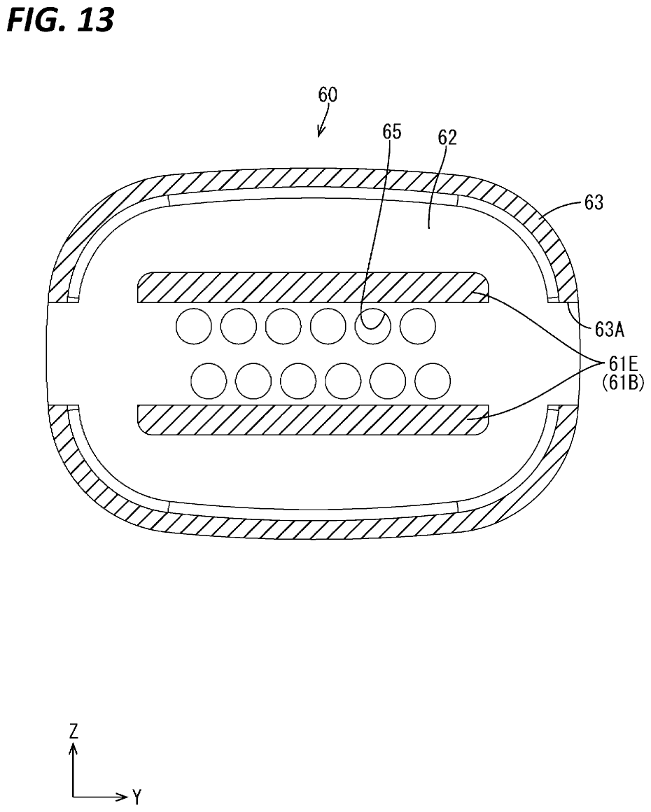

As shown in FIGS. 11 and 13, the seal mounting portion 61B is constituted by a pair of upper and lower mounting walls 61E. The front end of the upper mounting wall 61E is coupled to the rear end of the upper wall of the holder receptacle 61A, and the rear end of the upper mounting wall 61E is coupled to the holder base portion 62. The front end of the lower mounting wall 61E is coupled to the rear end of the lower wall of the holder receptacle 61A, and the rear end of the lower mounting wall 61E is coupled to the holder base portion 62. The collective sealing portion 70 is integrally mounted on the seal mounting portion 61B by two-color molding.

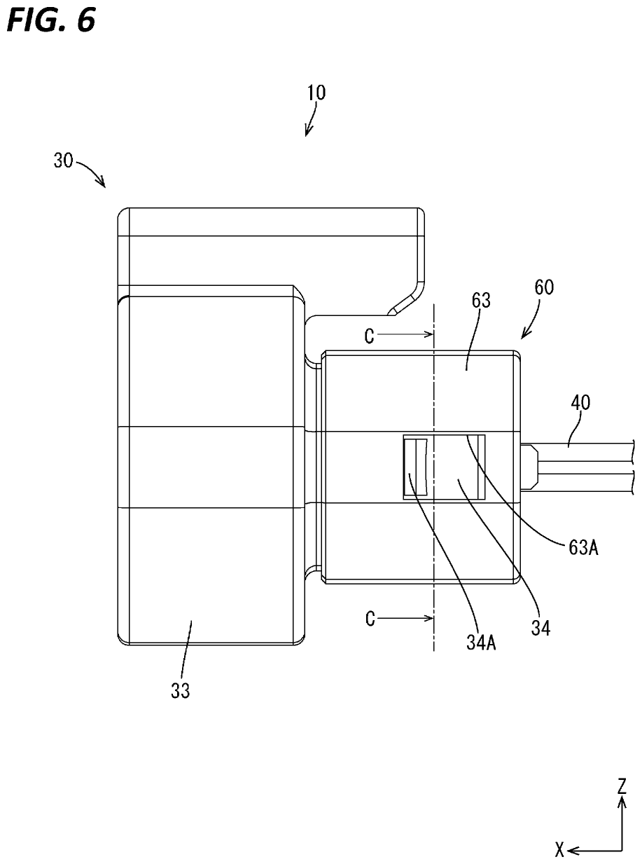

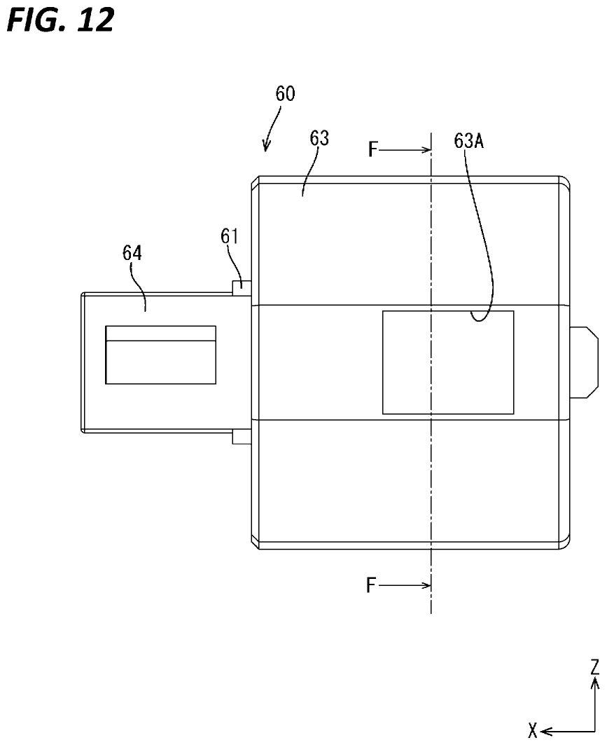

As shown in FIGS. 10 and 11, the protection wall 63 has a tubular shape open forward. The protection wall 63 has an oval shape long in the lateral direction when viewed from front. The holder body 61 is accommodated inside the protection wall 63. A pair of through holes 63A are provided in both left and right side walls of the protection wall 63. As shown in FIGS. 6 and 12, the through hole 63A has a rectangular shape long in the front-rear direction when viewed laterally.

As shown in FIGS. 12 and 13, a space between the pair of upper and lower mounting walls 61E are aligned with the through holes 63A when the rear holder 60 is viewed laterally. Therefore, the lower surface of the upper mounting wall 61E is disposed at the same height as the upper edge of the through hole 63A, and the upper surface of the lower mounting wall 61E is disposed at the same height as the lower edge of the through hole 63A.

### [Collective Sealing Portion]

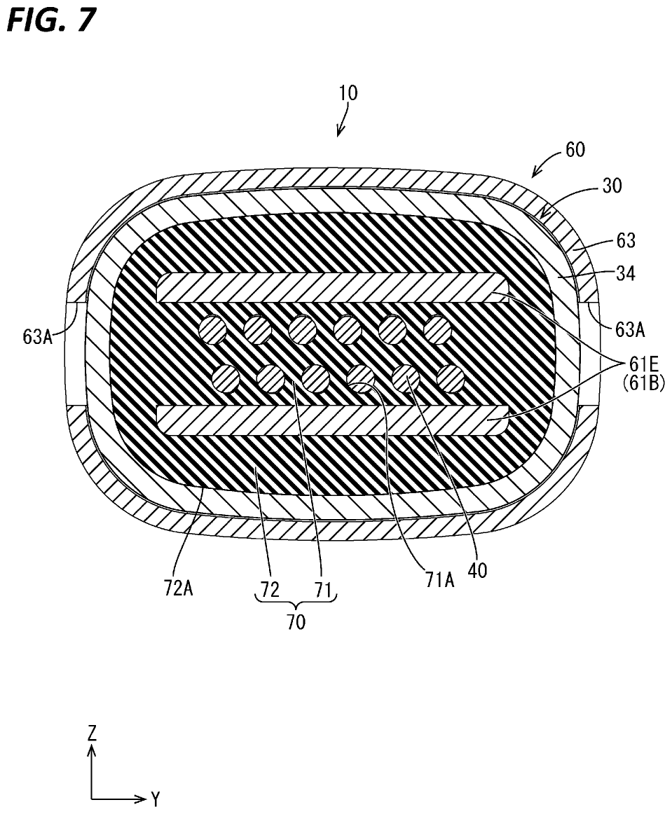

The collective sealing portion 70 is made of rubber and, as shown in FIG. 7, provided with an inner sealing portion 71 disposed between the pair of mounting walls 61E and an outer sealing portion 72 disposed on an outer peripheral side of the inner sealing portion 71.

The inner sealing portion 71 seals the wires 40 inserted through the wire insertion holes 65. As shown in FIG. 9, the inner sealing portion 71 includes inner peripheral lips 71A having a smallest inner diameter near a center in the front-rear direction. An inner diameter of the inner peripheral lip 71A is smaller than the outer diameter of the wire 40.

The outer sealing portion 72 includes outer peripheral lips 72A formed on the outer peripheral surface of the outer sealing portion 72. The outer peripheral lips 72A are provided over the entire periphery of the outer sealing portion 72. The outer peripheral lips 72A are covered by the protection wall 63. The outer sealing portion 72 seals between the outer housing 30 and the rear holder 60.

### [Outer Housing]

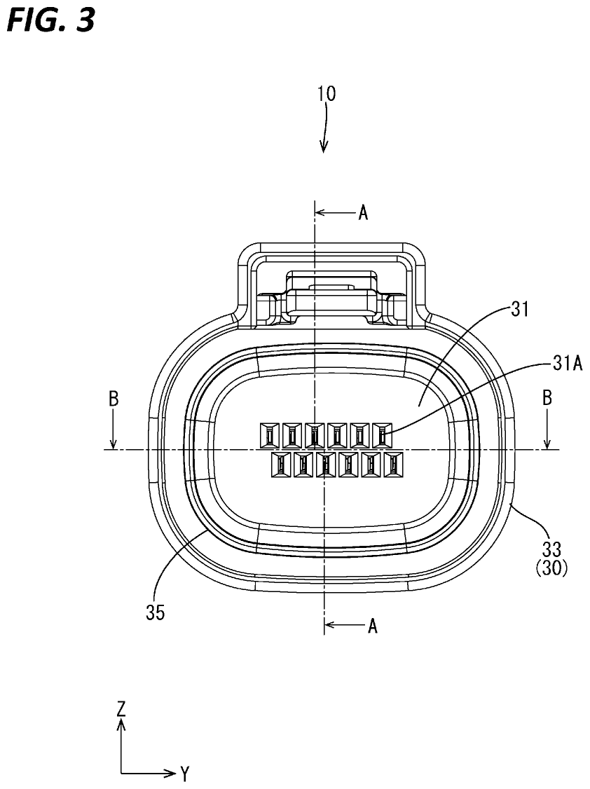

As shown in FIG. 4, the outer housing 30 is made of insulating synthetic resin and provided with a housing accommodating portion 31, a seal accommodating portion 32 disposed behind the housing accommodating portion 31, a front receptacle 33 disposed on an outer peripheral side of the housing accommodating portion 31 and open forward and a rear receptacle 34 disposed behind the front receptacle 33 and open rearward. As shown in FIG. 3, a plurality of terminal entrance holes 31A disposed to correspond to the positions of the plurality of cavities 21A of the inner housing 20 are provided in the front wall of the housing accommodating portion 31. The terminal entrance hole 31A is a hole, into which the male terminal (not shown) to be connected to the terminal 50 is inserted.

The inside of the housing accommodating portion 31 and that of the seal accommodating portion 32 communicate. A dimension in the front-rear direction of the housing accommodating portion 31 is larger than that of the seal accommodating portion 32 and about three times as large as that of the seal accommodating portion 32. A vertical dimension of the seal accommodating portion 32 is larger than that of the housing accommodating portion 31 as shown in FIG. 4, and a lateral dimension of the seal accommodating portion 32 is larger than that of the housing accommodating portion 31 as shown in FIG. 5.

The outer sealing portion 72 of the collective sealing portion 70 is accommodated in a sealed state inside the seal accommodating portion 32. The housing accommodating portion 31 includes a rear housing accommodating portion 31B for accommodating the holder receptacle 61A. The rear receptacle 34 is constituted by the rear housing accommodating portion 31B and the seal accommodating portion 32.

As shown in FIG. 5, the rear receptacle 34 includes lock protrusions 34A for holding a state where the protection wall 63 of the rear holder 60 is mounted along the outer peripheral surface of the rear receptacle 34 (state where the rear receptacle 34 is fit in the protection wall 63) by being locked to the inner walls of the through holes 63A. The lock protrusions 34A are located near the front end of the seal accommodating portion 32. With the rear receptacle 34 fit in the protection wall 63, the outer peripheral lips 72A of the outer sealing portion 72 are held in close contact with the seal accommodating portion 32, thereby sealing between the outer housing 30 and the rear holder 60.

The front receptacle 33 extends forward to the front end of the housing accommodating portion 31 after extending radially outward from the front end of the rear receptacle 34. The sealing ring 35 is mounted on the outer peripheral surface of the housing accommodating portion 31. A mating receptacle (not shown) of a mating housing can enter between the outer peripheral surface of the housing accommodating portion 31 and the inner peripheral surface of the front receptacle 33, and sealing is provided between the mating housing and the outer housing 30 by sandwiching the sealing ring 35 between the inner peripheral surface of the mating receptacle and the outer peripheral surface of the housing accommodating portion 31.

### [Connector Manufacturing Method]

Next, an example of a manufacturing method of the connector 10 of this embodiment is described. The manufacturing method of the connector 10 is not limited to the one described below.

The terminal body 51 and the slide portion 52 are formed by a known method. The slide portion 52 is assembled with the terminal body 51 from behind, and held at the temporary locking position. In this way, the terminal 50 is obtained.

By injection-molding the synthetic resin, the inner housing 20, the outer housing 30 and the rear holder 60 are formed. The terminals 50 are inserted into the cavities 21A of the inner housing 20 from behind. The rear holder 60 and the collective sealing portion 70 are integrally formed by two-color molding by injecting liquid rubber as a raw material of the collective sealing portion 70 into the rear holder 60. In this way, the inner sealing portion 71 and the outer sealing portion 72 are constituted by one member. This leads to a reduction in the number of components and a reduction in man-hours since a step of mounting the collective sealing portion 70 is eliminated.

The rear holder 60 is assembled with the rear end part of the inner housing 20 from behind. Then, front end parts of the lock receiving portions 64 of the rear holder 60 come into contact with the temporary lock portions 24 of the inner housing 20 from behind and the lock receiving portions 64 are expanded and deformed. If the rear holder 60 is pushed further forward, the lock receiving portions 64 are restored and the lock receiving portions 64 of the rear holder 60 are resiliently locked to the temporary lock portions 24 of the inner housing 20. In this way, the rear holder 60 is held at the temporary locking position with respect to the inner housing 20. In this state, the holder receptacle 61A of the rear holder 60 is disposed at a position separated rearward from the rear end of the inner housing 20.

By stripping the insulation coating 42 in the end part of the wire 40, the core wire 41 is exposed over a predetermined length. The front end part of the insulation coating 42 of the wire 40 is cut off by a wire stripper or the like to form the sheath portion 43 and the body portion 44. By sliding the sheath portion 43 forward with respect to the core wire 41, the front end part of the core wire 41 is protected by the sheath portion 43 (see FIG. 2).

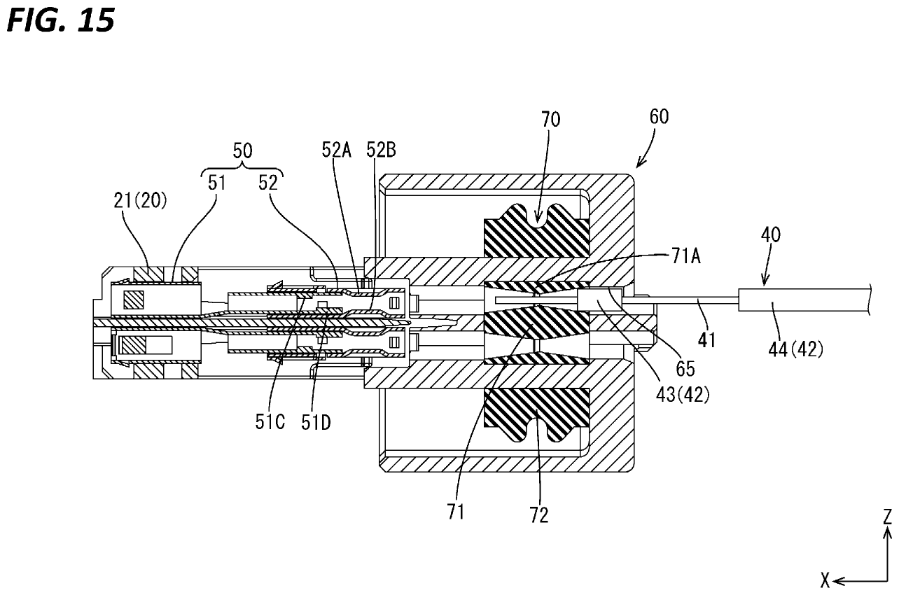

If the wire 40 having the front end part of the core wire 41 protected by the sheath portion 43 is inserted into the wire insertion hole 65 of the rear holder 60, the sheath portion 43 comes into contact with the inner sealing portion 71 as shown in FIG. 14. In this way, since the front end part of the core wire 41 is protected by the sheath portion 43 in this embodiment, the inner sealing portion 71 is hardly damaged due to the contact of the front end part of the core wire 41 with the inner sealing portion 71. If the wire 40 is pushed further forward, the core wire 41 is fed forward while the sheath portion 43 is kept in contact with the inner sealing portion 71 as shown in FIG. 15.

If the wire 40 is pushed further forward, the core wire 41 is introduced into the inside of the slide portion 52 through the rear end part of the slide portion 52. Then, as shown in FIG. 16, the front end part of the core wire 41 enters the terminal body 51 and reaches the space between the upper and lower connection pieces 51C, 51D. During this time, the sheath portion 43 is pushed out from behind by the body portion 44, thereby being disposed forward of the inner sealing portion 71. The inner peripheral lip 71A is held in close contact with the body portion 44.

By seeing the front end part of the core wire 41 or detecting this front end part by a probe or the like in the terminal window portion 51F visually confirmable through the connector window portion 21B, it can be confirmed that the core wire 41 has reached a predetermined position.

Subsequently, if the jig (not shown) is pushed into contact with the jig contact portion 54 from behind and the slide portion 52 is slid forward, the slide portion 52 is held at the complete locking position with respect to the terminal body 51. With the slide portion 52 held at the complete locking position with respect to the terminal body 51, the upper contact portion 52A of the slide portion 52 contacts the upper connection piece 51C of the terminal body 51 from above to press the upper connection piece 51C downward as shown in FIG. 4. Further, the lower contact portion 52B of the slide portion 52 contacts the lower connection piece 51D of the terminal body 51 from below to press the lower connection piece 51D upward. In this way, the core wire 41 is sandwiched from upper and lower sides by the upper and lower connection pieces 51C, 51D and the terminal 50 and the wire 40 are electrically connected.

Subsequently, the rear holder 60 is pushed further forward with respect to the inner housing 20. Then, the front end parts of the lock receiving portions 64 of the rear holder 60 ride on the complete lock portions 25 and are expanded and deformed. If the rear holder 60 is pushed further forward, the lock receiving portions 64 are restored and the lock receiving portions 64 of the rear holder 60 are resiliently locked to the complete lock portions 25 of the inner housing 20. In this way, the rear holder 60 is held at the complete locking position with respect to the inner housing 20. In this state, the holder receptacle 61A of the rear holder 60 is externally fit to the rear part of the inner housing 20 and the inner housing 20 and the rear holder 60 are integrally configured.

As shown in FIG. 4, with the rear holder 60 held at the complete locking position with respect to the inner housing 20, the inner peripheral lip 71A is held in close contact with the body portion 44. In this way, sealability by the inner sealing portion 71 can be ensured. If the inner peripheral lip 71A is held in close contact with the vicinity of a boundary between the sheath portion 43 and the body portion 44 unlike this embodiment, water may intrude through a gap between the sheath portion 43 and the body portion 44.

Subsequently, the rear holder 60 is assembled with the outer housing 30 from behind, whereby the inner housing 20 is accommodated into the housing accommodating portion 31. The protection wall 63 of the rear holder 60 is expanded and deformed and rides on the lock protrusions 34A of the outer housing 30. If the rear holder 60 is pushed further forward, the protection wall 63 is restored and the lock protrusions 34A are resiliently locked to the inner walls of the through holes 63A. In this way, the rear holder 60 is held in a state mounted on the outer housing 30. In this state, the outer sealing portion 72 of the collective sealing portion 70 is accommodated inside the seal accommodating portion 32 and the outer peripheral lips 72A are held in close contact with the inner peripheral surface of the seal accommodating portion 32. In the above way, the manufacturing of the connector 10 is completed.

### [Functions and Effects of Embodiment]

According to the embodiment, the following functions and effects are achieved.

The connector 10 according to the embodiment is provided with the wires 40 each including the core wire 41 and the insulation coating 42 covering the outer periphery of the core wire 41, the terminals 50 to be connected to the core wires 41, the inner housing 20 including the terminal accommodating portion 21 for accommodating the terminals 50 inside, the rear holder 60 to be attached to the rear part of the inner housing 20 and the collective sealing portion 70 to be mounted into the rear holder 60. The rear holder 60 includes the wire insertion holes 65, through which the wires 40 are inserted. The collective sealing portion 70 includes the inner sealing portion 71 for sealing the wires 40 inserted through the wire insertion holes 65. The insulation coating 42 of the wire 40 includes the sheath portion 43 and the body portion 44 separate from each other. The sheath portion 43 is disposed forward of the body portion 44 and slidable with respect to the core wire 41.

According to this configuration, by inserting the wire 40 into the wire insertion hole 65 with the front end part of the core wire 41 protected by the sheath portion 43, the front end part of the core wire 41 can be suppressed from contacting the inner sealing portion 71 of the collective sealing portion 70. Therefore, the damage of the collective sealing portion 70 can be suppressed.

In the embodiment, the inner sealing portion 71 seals the body portions 44.

According to this configuration, waterproofness by the collective sealing portion 70 can be ensured.

The connector 10 according to the embodiment is further provided with the outer housing 30 to be assembled with the rear holder 60 while accommodating the inner housing 20 inside, and the outer sealing portion 72 for sealing between the rear holder 60 and the outer housing 30.

According to this configuration, the insides of the inner housing 20 and the rear holder 60 can be waterproofed by providing the outer housing 30 and the outer sealing portion 72.

In the embodiment, the outer sealing portion 72 is integrally formed to the collective sealing portion 70.

According to this configuration, since the outer sealing portion 72 is integrally provided to the collective sealing portion 70, the number of components can be reduced.

In the embodiment, the collective sealing portion 70 and the rear holder 60 are constituted by one member.

According to this configuration, since the collective sealing portion 70 needs not be mounted into the rear holder 60, mounting man-hours can be reduced. For example, the collective sealing portion 70 and the rear holder 60 may be configured into one member by forming the collective sealing portion 70 in the rear holder 60 by two-color molding.

The manufacturing method of the connector 10 according to the embodiment is a manufacturing method for the connector 10 provided with the wires 40 each including the core wire 41 and the insulation coating 42 covering the outer periphery of the core wire 41, the terminals 50, the inner housing 20 including the terminal accommodating portion 21, the rear holder 60 including the wire insertion holes 65 and the collective sealing portion 70 to be mounted into the rear holder 60 for sealing the wires 40 inserted through the wire insertion holes 65, and includes accommodating the terminals 50 inside the terminal accommodating portion 21, attaching the rear holder 60 having the collective sealing portion 70 mounted therein to the rear part of the inner housing 20, cutting off the front end part of the insulation coating 42 of the wire 40 to form the sheath portion 43 and the body portion 44 disposed behind the sheath portion 43, protecting the front end part of the core wire 41 by the sheath portion 43 by sliding the sheath portion 43 forward with respect to the core wire 41, inserting the wire 40 having the front end part of the core wire 41 protected by the sheath portion 43 into the wire insertion hole 65 of the rear holder 60 and bringing the front end part of the core wire 41 to the inside of the terminal 50, and connecting the core wire 41 and the terminal 50.

Since such a manufacturing method of the connector 10 includes forming the sheath portion 43 in the insulation coating 42 and protecting the front end part of the core wire 41 by the sheath portion 43, the front end part of the core wire 41 can be suppressed from contacting the collective sealing portion 70 when the wire 40 is inserted into the wire insertion hole 65. Therefore, the damage of the collective sealing portion 70 can be suppressed.

### OTHER EMBODIMENTS

(1) Although the outer sealing portion 72 and the collective sealing portion 70 are integrally formed in the above embodiment, there is no limitation to this. An outer sealing portion may be separate from a collective sealing portion.

(2) Although the collective sealing portion 70 and the rear holder 60 are configured as one member in the above embodiment, there is no limitation to this and a collective sealing portion and a rear holder may be configured as separate members.

### LIST OF REFERENCE NUMERALS

10: connector
20 inner housing
21: terminal accommodating portion
21A: cavity
21B: connector window portion
22: separation wall
23: partition wall
24: temporary lock portion
25 complete lock portion
26 lance hole
30: outer housing
31: housing accommodating portion
31A: terminal entrance hole
31B: rear housing accommodating portion
32 seal accommodating portion
33: front receptacle
34: rear receptacle
34A: lock protrusion
35: sealing ring
40: wire
41: core wire
42: insulation coating
43: sheath portion
44: body portion
50: terminal
51: terminal body
51A: connecting tube portion
51B: base portion
51C: upper connection piece
51D: lower connection piece
51E: resilient contact piece
51F: terminal window portion
52: slide portion
52A: upper contact portion
52B: lower contact portion
53: locking lance
54: jig contact portion
60 rear holder
61: holder body
61A: holder receptacle
61B: seal mounting portion
61C: separation wall receiving portion
61D: step
61E: mounting wall
62: holder base portion
63: protection wall
63A: through hole
64: lock receiving portion
65 wire insertion hole
70: collective sealing portion
71 inner sealing portion
71A: inner peripheral lip
72: outer sealing portion
72A: outer peripheral lip

1. A connector, comprising:
a wire including a core wire and an insulation coating covering an outer periphery of the core wire;
a terminal to be connected to the core wire;
an inner housing including a terminal accommodating portion for accommodating the terminal inside;
a rear holder to be attached to a rear part of the inner housing; and
a collective sealing portion to be mounted into the rear holder,
the rear holder including a wire insertion hole, the wire being inserted through the wire insertion hole,
the collective sealing portion including an inner sealing portion for sealing the wire inserted through the wire insertion hole,
the insulation coating of the wire including a sheath portion and a body portion separate from each other, and
the sheath portion being disposed forward of the body portion and slidable with respect to the core wire.

2. The connector of claim 1, wherein the inner sealing portion seals the body portion.

3. The connector of claim 1, further comprising:
an outer housing to be assembled with the rear holder while accommodating the inner housing inside; and
an outer sealing portion for sealing between the rear holder and the outer housing.

4. The connector of claim 3, wherein the outer sealing portion is integrally formed to the collective sealing portion.

5. The connector of claim 4, wherein the collective sealing portion and the rear holder are constituted by one member.

6. A connector manufacturing method for a connector with a wire including a core wire and an insulation coating covering an outer periphery of the core wire, a terminal, an inner housing including a terminal accommodating portion, a rear holder including a wire insertion hole, and a collective sealing portion to be mounted into the rear holder, the collective sealing portion sealing the wire inserted through the wire insertion hole, comprising:
accommodating the terminal inside the terminal accommodating portion;
attaching the rear holder having the collective sealing portion mounted therein to a rear part of the inner housing;
forming a sheath portion and a body portion disposed rearward of the sheath portion by cutting off a front end part of the insulation coating of the wire;
protecting a front end part of the core wire by the sheath portion by sliding the sheath portion forward with respect to the core wire;
inserting the wire having the front end part of the core wire protected by the sheath portion into the wire insertion hole of the rear holder and bringing the front end part of the core wire to inside of the terminal; and
connecting the core wire and the terminal.
